(19) United States
(12) Patent Application Publication
(10) Pub. No.: US 2022/0337016 A1
(43) Pub. Date: Oct. 20, 2022

(54) OPTICAL AMPLIFIER

(71) Applicant: NIPPON TELEGRAPH AND TELEPHONE CORPORATION, Tokyo (JP)

(72) Inventors: Shinichi AOZASA, Musashino-shi, Tokyo (JP); Taiji SAKAMOTO, Musashino-shi, Tokyo (JP); Kazuhide NAKAJIMA, Musashino-shi, Tokyo (JP); Masaki WADA, Musashino-shi, Tokyo (JP)

(73) Assignee: NIPPON TELEGRAPH AND TELEPHONE CORPORATION, Tokyo (JP)

(21) Appl. No.: 17/760,697

(22) PCT Filed: Sep. 26, 2019
(86) PCT No.: PCT/JP2019/037907

§ 371 Date: Mar. 15, 2022

(51) Int. Cl. H01S 3/067

(52) U.S. Cl. CPC H01S 3/0675; H01S 3/06716

(57) ABSTRACT

An objective is to provide an optical amplifier having a core excitation configuration that improves amplification efficiency. An optical amplifier according to the present invention includes an excitation light conversion fiber 11 that absorbs first excitation light L1 propagating in a cladding and having a first wavelength and emits, into a core, spontaneous emission light having a second wavelength, an oscillator 12 for causing the spontaneous emission light to be reflected on two reflectors 15 to reciprocate the light within the core of the excitation light conversion fiber 11 and laser-oscillating second excitation light L2 having the second wavelength, and an amplification fiber 13 that is connected to the excitation light conversion fiber 11 and amplifies signal light with the second excitation light L2 supplied from the excitation light conversion fiber 11 to the core.

### TECHNICAL FIELD

The present disclosure relates to an optical amplifier disposed in an optical communication system in which spatially multiplexing (multi-core or multi-mode) optical fibers are used.

### BACKGROUND ART

For optical communication systems using single-mode optical fibers, optical amplifiers for amplifying an optical signal as it is without converting the optical signal into an electric signal have been put into practical use. Spatially multiplexing optical amplifiers are also expected to be used for optical communication systems using spatially multiplexing optical fibers (see, for example, NPL 1).

For spatially multiplexing optical amplifiers, a configuration in which excitation light beams are individually supplied to a core for amplification (a core excitation configuration) and a configuration in which excitation light beams are supplied to a cladding (a cladding excitation configuration) are known. The cladding excitation configuration can simultaneously amplify a plurality of spatial channels propagated in the cladding and can be simplified as compared with the core excitation configuration. Furthermore, the cladding excitation configuration is also expected to reduce power consumption as compared with a configuration in which optical amplifiers for core excitation are used for the number of spatial channels (for example, see NPL 2). In addition, the cladding excitation configuration can use a multi-mode laser diode (LD) as a light source and thus can increase optical power conversion efficiency as compared with a core excitation configuration that needs to use a single-mode LD as the light source.

### CITATION LIST

### Non Patent Literature

NPL 1: M. Wada et al., “Recent Progress on SDM Amplifiers”, We1E. 3, Proc. ECOC, (2018).
NPL 2: S. Jain et al.. “32-core Erbium/Ytterbium Doped Multi-Core Fiber Amplifier for Next Generation Space-Division Multiplexed Transmission System”, Optics Express, 25 (26), (2017).
NPL 3: K. S. Abedin et al., “Cladding-Pumped Erbium-Doped Multicore Fiber Amplifier”, Optics Express, 20 (18), (2012).

### SUMMARY OF THE INVENTION

### Technical Problem

However, the cladding excitation configuration has a problem that the amplification efficiency is inferior to that of the core excitation configuration because, of excitation light incident on the cladding, light beams that have not been coupled to the core are not used for amplification of optical signals. For example, in the 6-core EDFA of NPL 3, the signal light output intensity of excitation light of 10.6 W is 32 mW per core, and thus the optical conversion efficiency is only approximately 2%.

Therefore, in order to solve the problem described above, the present invention aims to provide an optical amplifier having a core excitation configuration that improves amplification efficiency.

### Means for Solving the Problem

In order to achieve the objective described above, in the optical amplifier according to the present invention, an optical fiber-type excitation light converter is disposed in front of an optical fiber for optical amplification, and the excitation light converter absorbs multi-mode excitation light incident on a cladding of an optical fiber into a core and converts the multi-mode excitation light into excitation light of the optical fiber for optical amplification.

Specifically, the optical amplifier according to the present invention includes: an excitation light conversion fiber configured to absorb first excitation light having a first wavelength and propagating in a cladding and emit spontaneous emission light having a second wavelength into a core; an oscillator configured to reflect the spontaneous emission light using two reflectors to reciprocate the light within the core of the excitation light conversion fiber, and laser-oscillate second excitation light having the second wavelength; and an amplification fiber connected to the excitation light conversion fiber and configured to amplify signal light with the second excitation light supplied from the excitation light conversion fiber to the core.

The present optical amplifier wavelength-converts excitation light propagated in multi-mode in the cladding and converts the excitation light into excitation light in the core. Thus, the present optical amplifier can have a core excitation configuration using a multi-mode LD with high optical power conversion efficiency as a light source, and can improve amplification efficiency as compared with a typical cladding excitation configuration. In addition, the present optical amplifier has an excitation light conversion unit inside the amplifier and can reduce excess loss caused by connection of signal light and excitation light in the outside, or the like.

Thus, the present invention can provide an optical amplifier with a core excitation configuration that improves amplification efficiency.

The optical amplifier according to the present invention has the following variations.

The amplification fiber of the optical amplifier according to the present invention may be disposed between the two reflectors of the oscillator.

In the optical amplifier according to the present invention, one amplification fiber is connected in series in the propagation direction of the signal light so as to be sandwiched between the two excitation light conversion fibers, and the oscillator disposed for each of the two excitation light conversion fibers, and the two reflectors of the oscillator are disposed at both ends of each excitation light conversion fiber.

Two amplification fibers of the optical amplifier according to the present invention may be disposed outside of the two reflectors of the oscillator.

The excitation light conversion fiber and the amplification fiber of the optical amplifier according the present invention may be a multi-core fiber or a multi-mode fiber.

Note that the above-described inventions can be combined to the extent possible.

### Effects of the Invention

The present invention can provide an optical amplifier with a core excitation configuration that improves amplification efficiency.

### BRIEF DESCRIPTION OF DRAWINGS

FIG. 1 is a diagram illustrating an optical amplifier according to the present invention.

FIG. 2 is a diagram illustrating an optical amplifier according to the present invention.

FIG. 3 is a diagram illustrating an optical amplifier according to the present invention.

FIG. 4 is a diagram illustrating an optical amplifier according to the present invention.

FIG. 5 are diagrams illustrating a structure of an excitation light conversion fiber of the optical amplifier according to the present invention. FIG. 5(A) illustrates a cross-sectional structure of the excitation light conversion fiber, and FIG. 5(B) illustrates an Yb concentration distribution.

### DESCRIPTION OF EMBODIMENTS

Embodiments of the present invention will be described with reference to the accompanying drawings. The embodiments described below are examples of the present invention, and the present invention is not limited to the embodiments described below. Note that constituent components with the same reference signs in the present specification and the drawings are assumed to be the same.

### First Embodiment

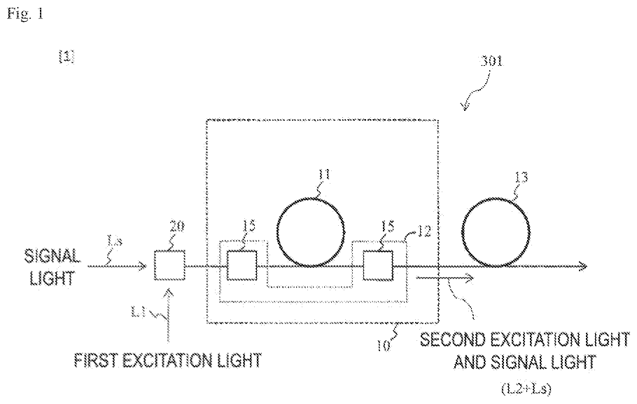

FIG. 1 is a diagram illustrating an optical amplifier 301 according to the present embodiment. The optical amplifier 301 includes

an excitation light conversion fiber 11 that absorbs first excitation light L1 having a first wavelength and propagating in a cladding and emits spontaneous emission light having a second wavelength into a core, an oscillator 12 that reflects the spontaneous emission light using two reflectors 15 to reciprocate the light within the core of the excitation light conversion fiber 11, and laser-oscillates second excitation light L2 having the second wavelength, and an amplification fiber 13 that is connected to the excitation light conversion fiber 11 and amplifies signal light with the second excitation light L2 supplied from the excitation light conversion fiber 11 to the core.

The optical amplifier 301 includes a multiplexer 20 that multiplexes signal light Ls and the first excitation light L1, a light source (not illustrated) that generates the first excitation light L1, an excitation light conversion fiber 11 that absorbs the first excitation light L1 and generates the excitation light L2 having a different wavelength, two reflectors 15 disposed in front of and behind the excitation light conversion fiber 11 to resonate the excitation light L2, and the amplification fiber 13 that amplifies the signal light Ls with supply of the second excitation light L2. An excitation light conversion unit 10 has a configuration including the excitation light conversion fiber 11 and the two reflectors 15 disposed in front of and behind the excitation light conversion fiber 11.

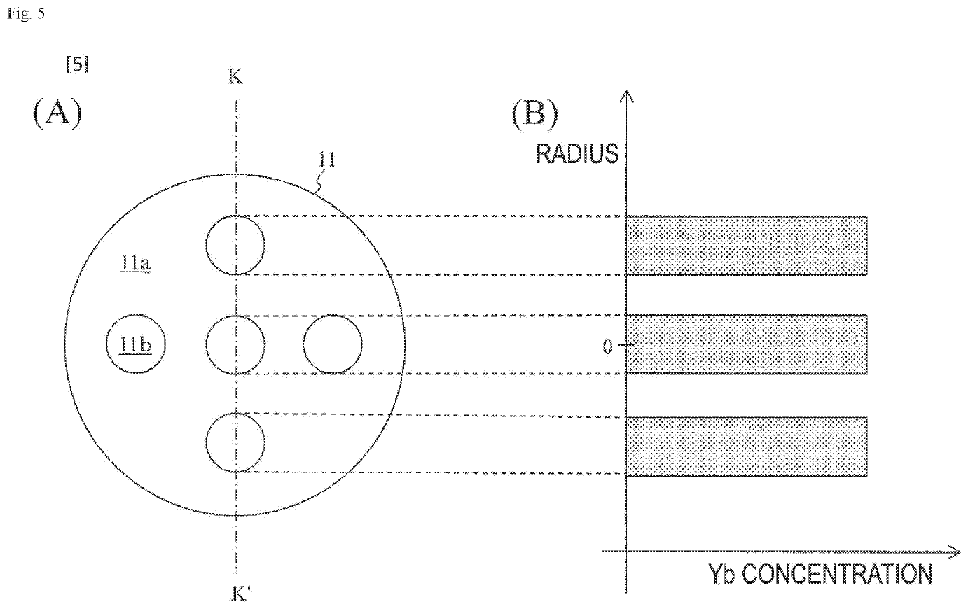

The amplification fiber 13 is, for example, an erbium-doped multi-core fiber (EDF). The excitation light conversion fiber 11 is, for example, an ytterbium (Yb)—doped multi-core fiber. FIG. 5(A) is a diagram illustrating a cross-section of the excitation light conversion fiber 11. 11a represents a cladding, and 11b represents a core. FIG. 5(B) is a diagram illustrating an Yb concentration distribution of the excitation light conversion fiber 11. The vertical axis indicates a radial position, and the horizontal axis indicates a concentration of Yb. Note that, although the present embodiment describes a multi-core optical fiber, the same applies to a multi-mode optical fiber.

Note that optical fibers of the optical amplifier according to the present invention are not limited according to the types of ions to be doped. In addition, the excitation light conversion fiber 11, the amplification fiber 13, and an optical fiber connecting the aforementioned fibers may have a solid-type structure or a hole-type structure such as a photonic crystal fiber bandgap fiber. Note that the excitation light conversion fiber 11 has a two-stage cladding structure so that the first excitation light L1 can propagate in the cladding.

The light source is a multi-mode LD that outputs the first excitation light L1 (for example, with a wavelength of 0.92 μm) in multi-mode. Further, the multiplexer 20 multiplexes the first excitation light L1 output from the light source with the signal light Ls and causes the multiplexed light to be incident on the excitation light conversion fiber 11. The first excitation light L1 is incident on the cladding of the excitation light conversion fiber 11, and the signal light Ls is incident on each core of the excitation light conversion fiber 11. The excitation light conversion fiber 11 emits spontaneous emission light in a 1 μm band into each core when absorbing the first excitation light L1 into the core.

The optical amplifier 301 has the reflectors 15 disposed in front of and behind the excitation light conversion fiber 11 to reflect the spontaneous emission light emitted to the core of the excitation light conversion fiber 11, and the optical amplifier 301 laser-oscillates light having a wavelength of 0.98 μm. The reflectors 15 are realized by forming, in the core of the optical fiber, a Bragg grating or a spatial filter that reflects only light having a specific wavelength. In addition, the reflectance of the rear reflector 15 (on the amplification fiber 13 side) may be lowered compared to that of the front reflector 15 (on the multiplexer 20 side). With the configuration described above, the light having the wavelength of 0.98 μm that has been laser-oscillated in the core is output to each core of the amplification fiber 13 as the second excitation light L2 that excites the rear amplification fiber 13. At this time, the signal light Ls is also output from each core of the excitation light conversion fiber 11 to each core of the amplification fiber 13.

The optical amplifier 301 can use light from a multi-mode LD with good optical power conversion efficiency of the light source used in the cladding excitation configuration as described above, as excitation light having the core excitation configuration with high amplification efficiency. Thus, the optical amplifier 301 can improve amplification efficiency in the cladding excitation configuration.

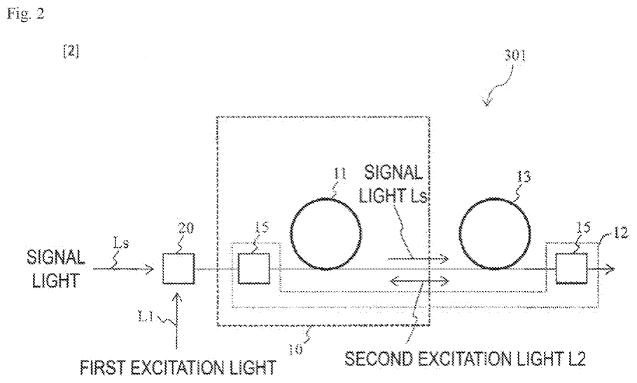

FIG. 2 is a diagram illustrating another embodiment of the optical amplifier 301. The amplification fiber 13 of the present embodiment is disposed between two reflectors 15 of the oscillator 12. The optical amplifier 301 of FIG. 2 differs from the optical amplifier 301 of FIG. 1 in that the position of the rear reflector 15 is disposed behind the amplification fiber 13. The optical amplifier 301 configured as in FIG. 2 can also achieve the effects described above.

The optical amplifier 301 has a structure that increases amplification efficiency in spatially multiplexing optical fibers, and can achieve long-range and high-capacity transmissions at low power consumption compared to conventional optical amplifiers of spatially multiplexing optical fibers. For example, the optical-optical conversion efficiency of the optical amplifier 301 is 30% on the assumption that the conversion efficiency of the first excitation light L1 (915 nm) to the second excitation light L2 (980 nm) in the excitation light conversion fiber 11 is 60%, and the conversion efficiency in the amplification fiber 13 is 50%. That is, the optical-optical conversion efficiency of the optical amplifier 301 is much higher than the optical-optical conversion efficiency (2%) of a conventional optical amplifier with the cladding excitation configuration.

### Second Embodiment

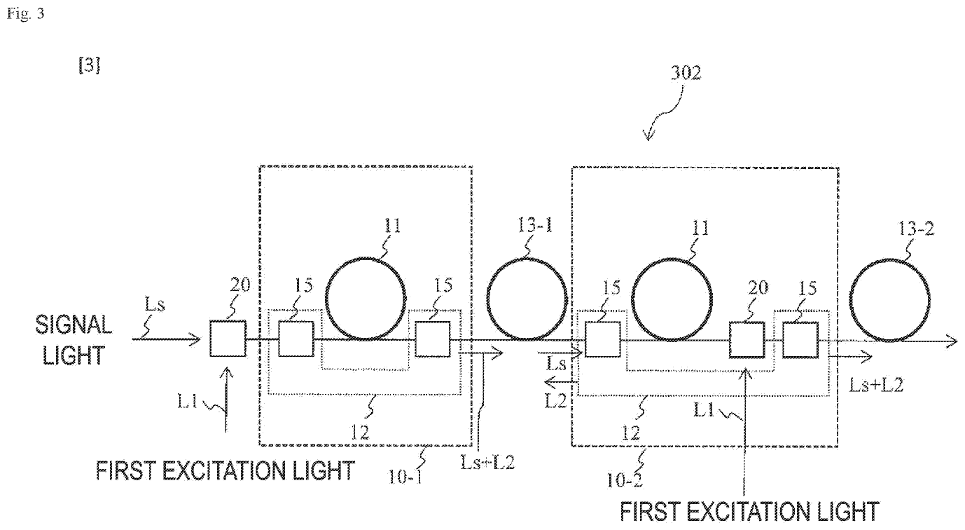

FIG. 3 is a diagram illustrating an optical amplifier 302 according to the present embodiment. The optical amplifier 302 is different from the optical amplifier 301 of FIG. 1 in the following points. IN the optical amplifier 302, one amplification fiber 13 is connected in series in the propagation direction of the signal light Ls so as to be sandwiched between the two excitation light conversion fibers 11, an oscillator 12 is disposed for each of the two excitation light conversion fibers 11, and two reflectors 15 of the oscillator 12 are disposed at both ends of each excitation light conversion fiber 11.

The optical amplifier 302 has a multiplexer 20, a front excitation light conversion unit 10-1, an amplification fiber 13-1, and a rear excitation light conversion unit 10-2 connected in order in the propagation direction of the signal light Ls. The multiplexer 20, the excitation light conversion unit 10-1, and the amplification fiber 13-1 are the same as those of the optical amplifier 301 of FIG. 1. The excitation light conversion unit 10-2 includes a multiplexer 20 between two reflectors 15. The excitation light conversion unit 10-2 converts first excitation light L1 propagating in the cladding into second excitation light L2 and causes the second excitation light L2 to be incident on each core of the amplification fiber 13-1 by adjusting the reflectance of the two reflectors 15. That is, the optical amplifier 302 can supply the second excitation light L2 from each of the two excitation light conversion units (10-1 and 10-2) to each core of the amplification fiber 13-1 to amplify the signal light Ls.

In addition, in the optical amplifier 302, an amplification fiber 13-2 may be further connected behind the excitation light conversion unit 10-2. The excitation light conversion unit 10-2 can cause the second excitation light L2 to be incident not only on each core of the amplification fiber 13-1 but also on each core of the amplification fiber 13-2 by adjusting the reflectance of the two reflectors 15. In this configuration, the optical amplifier 302 can amplify the signal light Ls with the two amplification fibers (13-1 and 13-2). The excitation light conversion unit 10-2 can adjust the intensity ratio of the second excitation light L2 output to the amplification fiber 13-1 side and the second excitation light L2 output to the amplification fiber 13-2 by arbitrarily changing the reflectance of the two reflectors 15.

### Third Embodiment

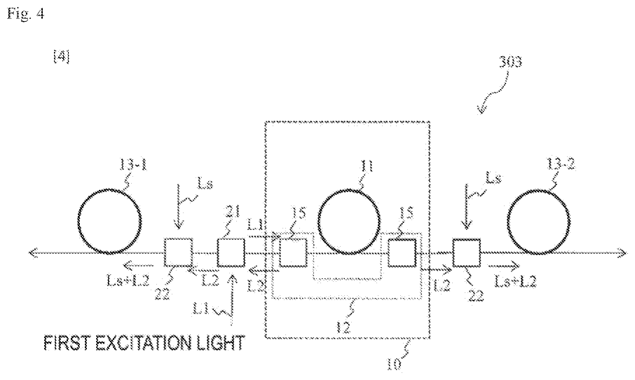

FIG. 4 is a diagram illustrating an optical amplifier 303 according to the present embodiment. The optical amplifier 303 is different from the optical amplifier 301 of FIG. 1 in the following points. In the optical amplifier 303, two amplification fibers 13 are disposed outside of two reflectors 15 of an oscillator 12. In other words, the optical amplifier 303 has an excitation light conversion unit 10 that supplies second excitation light L2 to both amplification fibers (13-1 and 13-2) located on both sides of the excitation light conversion unit 10 to simultaneously excite the amplification fibers (13-1 and 13-2).

First excitation light L1 from a light source is incident on one end of an excitation light conversion fiber 11 from a multiplexer 21. The structure of the excitation light conversion unit 10 is the same as that of the excitation light conversion unit 10 included in the optical amplifier 301 of FIG. 1. The first excitation light L1 incident on the excitation light conversion fiber 11 is converted into the second excitation light L2 and output from both ends of the excitation light conversion fiber 11. The output second excitation light L2 is multiplexed with the signal light L2 by a multiplexer 22 and is incident on each core of the amplification fibers (13-1 and 13-2). By arbitrarily changing the reflection ratio of two reflectors 15, the output intensity ratio of the second excitation light L2 to the amplification fibers (13-1 and 13-2) can be adjusted.

Additional Description

The following describes an optical amplifier according to the present embodiment.
(1): The present optical amplifier includes an optical amplifying unit that amplifies signal light, an excitation light generating unit that generates excitation light, a signal light multiplexer for causing the signal light to be incident on the signal light amplifying unit,
an excitation light multiplexer for causing first excitation light to be incident on the excitation light generating unit, and
a reflecting unit that reflects second excitation light newly generated by the excitation light generating unit.
The reflector is disposed on an input/output side of the excitation light generating unit, and the optical amplifying unit and the excitation light generating unit are connected (via a reflector).
(2): In the optical amplifier according to (1) described above, the optical amplifying unit and the excitation light generating unit are connected, and a plurality of the reflecting units are disposed to interpose the optical amplifying unit and the excitation light generating unit.
(3): In the optical amplifier according to (1) and (2) described above, at least one excitation light generating unit and at least one second excitation light source are disposed in a middle stage of two or more signal light amplification fibers.
(4): In the optical amplifier according to (1) to (3) described above, the signal light amplification fiber is an erbium-doped fiber optical amplifier.
(5): In the optical amplifier according to (1) to (4) described above, the wavelength conversion unit is an ytterbium-doped optical fiber.
(6): In the optical amplifier according to (1) to (5) described above, the reflecting unit is a fiber Bragg grating or a multilayer filter that reflects a specific wavelength.
(7): In the optical amplifier according to (1) to (6) described above, the wavelength conversion unit and the signal light amplification fiber are multi-core or multi-mode fibers.
(8): In the optical amplifier according to (1) to (7) described above, an incidence wavelength with respect to the excitation light generating unit is 900 to 960 nm, and a wavelength of the second excitation light is 965 to 1010 nm.
(9): In the optical amplifier according to (7) described above, an excitation light multiplexer is designed such that first excitation light propagates in a cladding region of the excitation light generating unit, and second excitation light is generated in a plurality of waveguides through which a plurality of signals propagate in the excitation light generating unit.

The present optical amplifier has the following effects and features:

(a) High-power multi-mode excitation light from the light source is wavelength-converted and absorbed from a cladding into a core. Thus, a core excitation configuration can be realized using a light source for cladding excitation.
(b) When an Yb-doped fiber is used as a wavelength conversion fiber for generating second excitation light having a wavelength of 980 nm, a light source that outputs light having a wavelength of about 900 nm to 960 nm is used.
(c) Light absorbed into the core by the wavelength conversion fiber propagates in the core as light having a wavelength of 980 nm and excites an EDF for amplification.

### REFERENCE SIGNS LIST

10, 10-1, 10-2 Excitation light conversion unit
11 Wavelength conversion fiber
11 a Cladding
11b Core
12 Oscillator
13, 13-1, 13-2 Amplification fiber
15 Reflector
20, 21, 22 Multiplexer
301 to 303 Optical amplifier

1. An optical amplifier comprising:
an excitation light conversion fiber configured to absorb first excitation light propagating in a cladding and having a first wavelength and emit, into a core, spontaneous emission light having a second wavelength;
an oscillator configured to reflect the spontaneous emission light using two reflectors to reciprocate the spontaneous emission light in the core of the excitation light conversion fiber and laser-oscillate second excitation light having a second wavelength; and
an amplification fiber connected to the excitation light conversion fiber and configured to amplify signal light using the second excitation light supplied from the excitation light conversion fiber to the core.

2. The optical amplifier according to claim 1, wherein the amplification fiber is disposed between the two reflectors of the oscillator.

3. The optical amplifier according to claim 1,
wherein one amplification fiber is connected in series in a propagation direction of the signal light so as to be sandwiched between two excitation light conversion fibers,
the oscillator is disposed for each of the two excitation light conversion fibers, and the two reflectors of the oscillator are disposed at both ends of each excitation light conversion fiber.

4. The optical amplifier according to claim 1, wherein two amplification fibers are disposed outside the two reflectors of the oscillator.

5. The optical amplifier according to claim 1,
wherein the excitation light conversion fibers and the amplification fibers are multi-core fibers or multi-mode fibers.
